(19) United States
(12) Patent Application Publication
(10) Pub. No.: US 2010/0027000 A1
(43) Pub. Date: Feb. 4, 2010

(54) Hybrid Technique for Coherent Anti-Stokes/Stokes Raman Spectroscopy

(76) Inventors: Dimitry Pestov, Okemos, MI (US); Alexei V. Sokolov, College Station, TX (US); Marlan O. Scully, Bryan, TX (US); Robert Murawski, Denville, NJ (US); Ariunbold Gombojav, College Station, TX (US); Xi Wang, College Station, TX (US); Vladimir Sautenkov, College Station, TX (US)

Correspondence Address: Tod T. Tumey, P.O. BOX 22188, HOUSTON, TX, 77227-2188, US

(21) Appl. No.: 12/259,831

(22) Filed: Oct. 28, 2008

Related U.S. Application Data
(60) Provisional application No. 60/983,558, filed on Oct. 29, 2007.

(51) Int. Cl. G01J 3/44

(52) U.S. Cl. 356/301

(57) ABSTRACT

A method and system provide coherent anti-Stokes Raman spectroscopy. In an embodiment, the system includes a detection system for measuring coherent anti-Stokes Raman signals of a sample. The system includes a first light pulse and a second light pulse. The first light pulse and the second light pulse are operable to initiate coherent vibration in the sample. The system also includes a third light pulse. The third light pulse is a probe pulse that is operable to produce scattered radiation from the sample. In addition, the system includes a spectral filter. The spectral filter shapes the probe pulse. The system further includes a detector to record the spectrum of the scattered radiation.

### CROSS-REFERENCE TO RELATED APPLICATIONS

This application is a non-provisional application that claims the benefit of U.S. application Ser. No. 60/983,558 filed on Oct. 29, 2007, which is incorporated by reference herein in its entirety.

### STATEMENT REGARDING FEDERALLY SPONSORED RESEARCH OR DEVELOPMENT

This invention was made with Government support under award no. N00014-03-1-0385 by the Office of Naval Research, Defense Advanced Research Projects Agency, and the National Science Foundation grant no. PHY-0354897. The Government has certain rights in this invention. This work was also supported by awards from the Research Corporation and the Robert A. Welch Foundation under grant nos. A-1261 and A-1547.

### BACKGROUND OF THE INVENTION

1. Field of the Invention

This invention relates to the field of spectroscopy and more specifically to coherent anti-Stokes/Stokes Raman spectroscopy.

2. Background of the Invention

Raman spectroscopy provides insight into the structure and dynamics of a molecule. For instance, the Raman vibrational spectrum of molecules provides a fingerprint for species identification. Raman spectroscopy includes a variety of techniques. Conventionally, two underlying processes form the foundation of Raman spectroscopy. One process is a spontaneous inelastic scattering of photons of a frequency ωₚᵣ on molecular vibrations with a gain or loss of vibrational quanta ωᵥ (i.e., ω_{SpRaman}=ωₚᵣ±ωᵥ. The second process is the coherent anti-Stokes/Stokes Raman scattering (CARS/CSRS) that is due to macroscopic oscillations of molecular polarization induced by pump and Stokes laser fields with the difference frequency (ωₚ−ωₛ) tuned close to the vibrational resonance. Typically, when molecules are put into coherent oscillation by a pair of preparation pulses with a third pulse scattered off this coherent molecular vibration, a strong anti-Stokes signal can be generated.

Drawbacks include the presence of the non-resonant (NR) four-wave mixing (FWM) signal from other molecules (i.e., background molecules). Such unwanted NR FWM is typically much stronger than the resonant signal because there may be more background molecules than the target molecules. The Raman-resonant signal may also be obscured by contributions from multiple off-resonant vibrational modes of the target molecules and the instantaneous electronic response. In addition, fluctuations of the NR background may completely wash out the CARS signature. A variety of methods have been developed to increase the signal-to-background ratio. Such methods include polarization-sensitive techniques, heterodyne, and interferometric schemes. Drawbacks to such methods include that such methods are not efficient in samples that exhibit strong multiple optical scattering. For instance, the scattering may randomize the spectral phases and polarization.

Multi-frequency acquisition of a CARS signal has also been developed to overcome such drawbacks. The multi-frequency acquisition along with the multi-channel detection and with a combination of narrowband pump-probe and broadband Stokes pulses has been used to address a wide range of vibrational frequencies. In such a scheme, the amount of NR background is typically addressed by polarization-sensitive techniques, heterodyne, and interferometric schemes. Drawbacks include that such methods typically do not work in the presence of strong multiple scattering in rough samples.

A delayed probe has also been developed for use in time-resolved CARS. Such technique uses ultra-short pulses for preparation and probing. The source of species-specific information for the technique is multi-mode interference in the probe-delay signal profile, which is typically referred to as quantum beats. The time-resolved CARS may eliminate the NR contribution by delaying the probe pulse, but drawbacks include the technique remaining vulnerable to fluctuations. For instance, the use of the multi-mode interference pattern for species recognition may require the ability to record high-quality quantum beat profiles over a relatively large probe delay span and may be challenging in the presence of scattering and fluctuations.

Consequently, there is a need for a spectroscopic method and system that reduces the amount of unwanted NR FWM signals that may arise together with CARS.

### BRIEF SUMMARY OF SOME OF THE PREFERRED EMBODIMENTS

These and other needs in the art are addressed in one embodiment by a detection system for measuring coherent anti-Stokes Raman signals of a sample. The system includes a first light pulse and a second light pulse. The first light pulse and the second light pulse are operable to initiate coherent vibration in the sample. The system also includes a third light pulse. The third light pulse is a probe pulse that is operable to be inelastically scattered from the sample. In addition, the system includes a spectral filter. The spectral filter shapes the probe pulse. The system further includes a detector to detect the scattered radiation.

These and other needs in the art are addressed in another embodiment by a coherent anti-Stokes Raman spectroscopy method. The method includes illuminating a sample with a first light pulse and a second light pulse. The first light pulse and the second light pulse initiate coherent vibration in a sample. The method further includes shaping a third light pulse to produce a shaped third light pulse. In addition, the method includes illuminating the sample with the shaped third light pulse. The shaped third light pulse is operable to be scattered from the sample. The method also includes detecting the scattered radiation.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifyng or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a detection system for coherent anti-Stokes/Stokes Raman spectroscopy;

FIG. 2 illustrates a two-dimensional CARS spectra of NaDPA powder;

FIG. 3 illustrates cross-sections of spectrograms at two different probe delays;

FIG. 4 illustrates absolute frequencies of observed Raman transitions of NaDPA powder;

FIG. 5 illustrates extracted CARS contributions of Bacillus Subtilis spores; and

FIG. 6 illustrates Raman transitions of Bacillus Subtilis spores in the excitation band.

### DETAILED DESCRIPTION OF THE PREFERRED EMBODIMENTS

In an embodiment, a spectroscopic technique includes combining a generalized broadband or multiplex CARS technique with background reduction by using an optimal sequence of coherent excitation and time-delayed probe pulses. In embodiments, the spectroscopic technique includes a probe and two preparation pulses that include a separate pump and Stokes. By adjusting a probe pulse delay and a spectral width, the NR background may be suppressed. Some embodiments include a coherent broadband excitation of several characteristic molecular vibrations in the spectral fingerprint region with subsequent probing of such vibrations by an optimally-shaped, time-delayed narrowband laser pulse. Without limitation, such embodiments allow for a single shot acquisition of a CARS/CSRS spectrum within the excitation band and effective suppression of the interfering non-resonant background due to the instantaneous electronic response and off-resonant Raman transitions.

It is to be understood that when a material is illuminated by an electromagnetic field, the response of the material may be formulated in terms of the induced polarization, which may result from the interaction of the field with the molecules in the material. The field displaces the positive and negative electric charge in the molecules, which may cause the molecules to polarize. Without limitation, the induced macroscopic polarization of the material may be represented according to a power series expansion of the applied electromagnetic field (E), i.e., P(E)=χ⁽¹⁾E+χ⁽²⁾E²+χ⁽³⁾E³+ . . . χ⁽¹⁾ refers to the linear susceptibility of the medium, while χ^{(2) and χ}⁽³⁾ refer to the second and third-order nonlinear susceptibilities, respectively. In Raman scattering, a concern is with the third term in the expansion, representing the third-order polarization. In CARS, the third-order polarization is a function of the third-order susceptibility, χ⁽³⁾, and the product of the electromagnetic fields from the pump beam, Stokes beam, and probe beam. The intensity of coherent Raman scattering is proportional to the squared modulus of the induced third-order polarization (|P⁽³⁾(χ)|²). In an embodiment, a third-order polarization induced by the pump, Stokes, and probe pulses may be split into resonant and non-resonant (NR) contributions. Without limitation, if it is assumed that no electronic resonances are involved, the third-order polarization may be attributed to a vibrationally resonant contribution and to a NR contribution from far-detuned Raman transitions. The NR component (χ_{NR}⁽³⁾) of the nonlinear susceptibility may usually be frequency-insensitive within the considered spectral band and may be treated as a constant. The resonant component of the third-order polarization is attributed to the Raman transitions of interest. The resonant component, assuming Lorentz-shaped Raman lines, may be presented as the following Equation (1).

χ_{R}⁽³⁾(ω₁−ω₂)=ΣⱼAⱼΓⱼ/(Ωⱼ−(ω₁−ω₂)−iΓⱼ)

Ωⱼ and Γⱼ denote the vibrational frequency and Raman line half-width, respectively. Aⱼ is a constant related to the spontaneous Raman cross-section and molecular density. ω₁ is the frequency of the pump field, and ω₂ is the frequency of the Stokes field. The summation is held over all Raman transitions involved.

In the frequency domain, the third-order polarization may be written as the following Equation (2).

P⁽³⁾(ω)=P_{NR}⁽³⁾(ω)+P_{R}⁽³⁾(ω)=∫₀^{+∞}dΩ×(χ_{NR}⁽³⁾+χ_{R}⁽³⁾(Ω))E₃(ω−Ω)×S₁₂(Ω)

E₃(ω) is the spectral amplitude of the probe pulse. S₁₂(Ω) is represented by the following Equation (3).

S₁₂(ω)≡∫₀^{+∞}dω′×E₁(ω′)E₂*(ω′−Ω)

S₁₂(Ω) is the convolution of the pump and Stokes field amplitudes, which are E₁(ω) and E₂(ω), respectively. It is to be understood that the signal arising from the nonlinear response of the medium is proportional to |P⁽³⁾(ω)|². Therefore, without limitation, the spectra generally have complex shapes caused by the interference between both resonant contributions from different vibrational modes and the NR background.

As shown in Equation (3), the convolution of the pump and Stokes spectra (S₁₂(Ω)) is factored into the resonant component and the non-resonant component of the third-order polarization equally. S₁₂(Ω) defines a Raman frequency band covered by the preparation pulses and is maximized for transform-limited pulses (i.e., pulses with the constant spectral phase). Without limitation, the difference between the two contributions of the resonant and non-resonant components results from the frequency-insensitive NR and frequency-dependent resonant susceptibility of the targeted molecule. The contribution of the latter component may be enhanced by shaping the spectral amplitude of the probe pulse, as represented by |E₃(ω)|. Further, without limitation, if a narrowband probe is applied together with the broadband transform-limited preparation pulses, the NR contribution may inherit a smooth, featureless profile of S₁₂(Ω) with some characteristic width Δω₁₂, whereas the resonant component generates a set of narrow peaks with a peak for each excited vibrational mode. In an embodiment, the spectral width of each resonant peak is determined by the greater of the Raman line width or the probe spectral width (Δω₃). The amplitude ratio between the resonant signal and the NR background at a Raman-shifted frequency is also affected by the spectral width of the probe pulse. For a probe spectral width between the Raman line width and the width of the pump-Stokes convolutional profile, corresponding to the integral of the product of the pump and Stokes spectral line shapes (i.e., Γ<<Δω₃<<Δω₁₂), the amplitude ratio at zero probe delay, when the probe intersects with material at about the same time as the preparatory pulses, is inversely proportional to the square of the probe spectral width. This ratio plateaus when the probe pulse spectral width reaches the limits of either the Raman line width or the pump-Stokes convolutional profile. Without limitation, a desired signal-to-background ratio results in an embodiment in which the probe spectral width is on the order of the Raman line width. In alternative embodiments, the contribution of a component may be enhanced by the use of a properly shaped probe by modifying the spectral phase of the probe.

In an embodiment, optimization of the spectroscopic technique further includes adjusting the probe pulse delay. In some embodiments, in the plane of two parameters (i.e., the probe pulse duration and its delay), the resonant response peaks for the two on the order of inverse Raman line width. The NR FWM at the Raman-shifted frequency peaks at zero probe delay and also when its duration is matched to the time span of the pump-Stokes convolution profile. In some embodiments, the probe pulse delay and the probe pulse spectral width are controlled. In an embodiment, the probe pulse delay and the probe pulse spectral width are controlled simultaneously. Without limitation, controlling the probe pulse delay and the probe pulse spectral width may achieve a close-to-optimal resonant response with reasonable suppression of the NR background. The actual optimal values of the parameters may depend on the Raman line width, the sensitivity of the setup used, and the relative strength of the resonant and NR susceptibilities. The probe pulse spectral width may be controlled by any suitable method. In an embodiment, the probe pulse spectral width is controlled through spectral amplitude shaping. By controlling the probe pulse spectral width and delay relative to the preparation pulses, the benefits of CARS signal discrimination against the NR FWM are combined with the NR background suppression (i.e., as accomplished in time-resolved CARS).

In some embodiments, the spectroscopic technique includes tailoring (i.e., shaping) of the probe pulse. Without limitation, proper tailoring of the probe pulse may facilitate reduction of the contribution of the NR background for probe delays comparable to the temporal length of the probe. For instance, a rectangular-shaped spectrum provides a sinc-squared temporal profile (i.e., ˜[sin(Δω₃t/2) (Δω₃t/2)]²) of the probe pulse intensity. Such a profile has points in time in which the pulse electric field amplitude goes to zero (i.e., temporal nodes). By delaying the probe pulse so that the preparation pulses coincide in time with one of the temporal nodes of the probe pulse, the NR background may be suppressed.

In an embodiment, the spectral resolution is determined by the probe bandwidth for data taken at a single fixed probe delay. It is to be understood that this is not an intrinsic limit and improved resolution may be achieved by recording the anti-Stokes spectrum for several probe pulse delays, with the measurements not being overwhelmed by the fluctuations. The actual bandwidth of the Raman transition may be re-constructed from the evolution of the CARS spectrum as a function of the probe timing.

In an embodiment, Raman spectra are obtained using a coherent broadband excitation of one or more characteristic molecular vibrations in the spectral fingerprint region of the molecule of interest. The molecular vibrations are probed by an optimally-shaped narrowband laser pulse that may be time-delayed. The embodiment includes broadband excitation of molecular vibrations by means of ultra-short preparation pulses, frequency-resolved probing of the excited Raman transitions with a narrow-band optimally-shaped probe pulse, multi-channel acquisition of the generated CARS/CSRS signal, and non-resonant background suppression by delaying the probe pulse and the use of pulse shaping.

In an embodiment, two ultra-short laser pulses may be used to prepare a coherent molecular vibration. The coherent molecular vibration may correspond to a particular vibrational eigenmode of the molecule. A third time-delayed, spectrally-narrow probe pulse scatters off of the oscillation and yields the frequency-shifted anti-Stokes signal. A multi-channel detector may be used to simultaneously record the anti-Stokes signal at all optical frequencies within the frequency band of interest, which may yield the single-shot acquisition of the CARS spectrum. By using a spectrally-narrow probe pulse, discrimination between the resonant contribution and NR background is accomplished, and the CARS signal is extracted even at zero probe delay. The probe pulse delay is used as a means to suppress the interfering FWM and associated noise.

In another embodiment, a coherent anti-Stokes Raman spectroscopy method includes illuminating a sample with a single broadband laser pulse to coherently excite at least one vibrational mode of a molecule in the sample. The method also includes illuminating the sample with a probe light pulse to inelastically scatter radiation from the excited vibrational mode in the molecule of the sample in an embodiment in which the probe light pulse is shaped and temporally delayed relative to the preparation probe light pulses to reduce non-resonant contributions to the scattered radiation from the sample. The method also includes detecting the scattered radiation. In an embodiment, the method also includes adjusting the spectral content of the preparation light pulses to homogeneously excite the largest possible band of Raman frequencies allowed by the spectral width of the preparation light pulses. The probe light pulse may be temporally delayed relative to the coherent excitation of the at least one vibrational mode to reduce the non-resonant contribution to the detected scattered radiation. The probe light pulse may have a pulse duration, which may be adjusted to maximize the contrast between the resonant and non-resonant contributions. The probe light pulse has a sinc-squared temporal profile. The probe light pulse may be delayed (i.e., by an adjustable delay) to provide the preparation pulses within a node of the sine-squared temporal profile of the probe light pulse.

In another aspect, a system for measures coherent anti-Stokes Raman signals from a sample. The system includes a first light source that provides a first light pulse and a second light source that provides a second light pulse. The first and second light pulses coherently excite a vibrational mode in a sample. The system includes a third light source that provides a probe pulse to produce scattered radiation from the sample. In addition, the system includes a spectral device to control the spectral content of the probe pulse to reduce the non-resonant contribution to the scattered radiation from the sample. The system also includes a detector to detect the scattered radiation. Some embodiments include the first and second light pulses provided from the same light source. In an embodiment, the first and second light sources are sub-picosecond/femtosecond pulsed laser sources. In some embodiments, the detector may detect a plurality of frequencies from the electromagnetic spectrum simultaneously. The detector may be a spectrometer with a charge-coupled device (CCD). Alternatively, the detector may be a spectrometer with a photodiode array. The spectral device is a bandpass filter, cut off filter, or a spectrally-dispersing pulse shaper with a spectral filter or liquid crystal modulator.

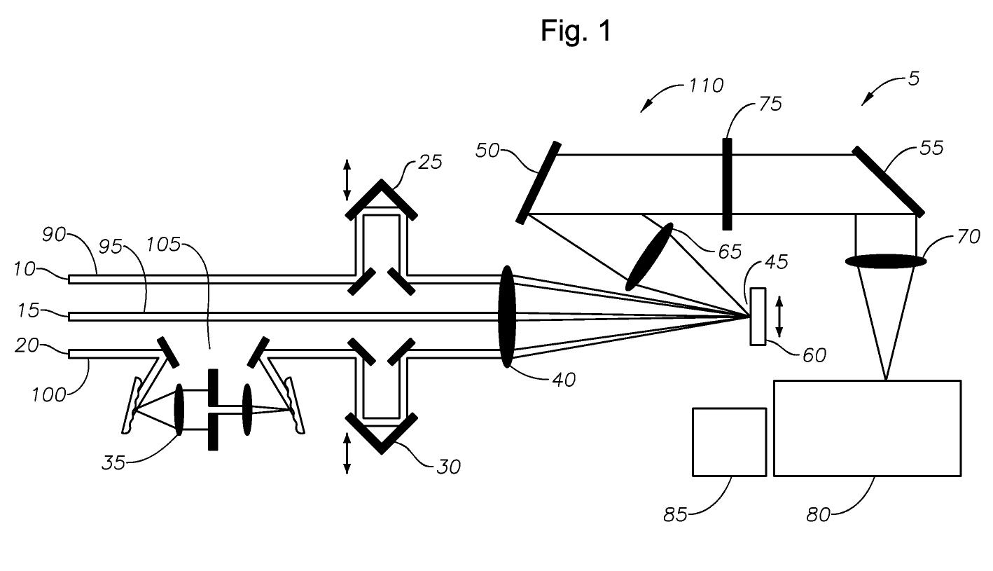

FIG. 1 illustrates an embodiment of a detection system 5 for coherent anti-Stokes/Stokes Raman spectroscopy of a sample 45. Sample 45 may be any sample suitable for Raman spectroscopy. In an embodiment, detection system 5 is used for species identification of sample 45. Detection system 5 includes a first light source 10, a second light source 15, and a third light source 20. First light source 10 provides a first light pulse 90. In an embodiment, first light pulse 90 is the Stokes pulse. First light source 10 may be any coherent light source suitable for providing a Stokes beam. In an embodiment, first light source 10 is a regenerative amplifier. In some embodiments, first light source 10 is a sub-picosecond light source. In an embodiment, first light pulse 90 is passed through first delay stage 25. First delay stage 25 may include any suitable method for delaying a light pulse. In some embodiments, first delay stage 25 is a computer controlled delay stage. In an embodiment, first light pulse 90 together with second light pulse 95 initiates coherent vibration in sample 45.

As shown in FIG. 1, second light source 15 provides a second light pulse 95. In an embodiment, second light pulse 95 is the pump pulse. Second light source 15 may be any coherent light source suitable for providing a pump beam. In an embodiment, second light source 15 is an optical parametric amplifier (OPA) pumped by first light source 10. In some embodiments, second light source 15 is a sub-picosecond laser light source synchronized with first light source 10. In an embodiment, second light pulse 95 together with first light pulse 90 initiates coherent vibration in sample 45.

As further shown in FIG. 1, third light source 20 provides a third light pulse 100. In an embodiment third light pulse 100 is the probe pulse. Third light source 20 may be any light source suitable for providing a probe beam. In an embodiment, third light source 20 is an optical parametric amplifier (OPA) pumped by first light source 10. In some embodiments, third light source 20 is a sub-picosecond laser source synchronized with other light sources. Third light pulse 20 is sent through a spectral filter 35. Spectral filter 35 may include any spectral filter suitable for shaping third light pulse 100. For instance, spectral filter 35 may be a pulse shaper with a slit or a liquid crystal modulator, a narrow-band interference filter, a cut-off filter, or the like. FIG. 1 illustrates an embodiment of detection system 5 in which spectral filter 35 has a slit 105. The pulse shaper with a slit may include an adjustable slit or a non-adjustable slit. In an embodiment, the slit is adjustable. Without limitation, the slit cuts the spectral bandwidth of third light pulse 100. Third light pulse 100 passes through spectral filter 35 to second delay stage 30. Second delay stage 30 may include any suitable method for delaying a light pulse. In an embodiment, second delay stage 30 is a computer controlled delay stage. It is to be understood that detection system 5 is not limited to passing third light pulse 100 through a spectral filter 35 but instead includes alternative embodiments not having a spectral filter 35 through which third light pulse 100 passes. For instance, in an alternative embodiment (not illustrated), third light source 20 is a light source with a desired narrow-band spectrum. In an alternative embodiment (not illustrated), the light source with a desired narrow-band output spectrum is a narrow-band OPA. In another alternative embodiment (not illustrated), third light source 20 is a second harmonic generator (SHG). In such alternative embodiment, a thick nonlinear crystal is used to produce a narrow-band light via SHG from the light of first light source 10 or second light source 15. In an embodiment, SHG provides a probe pulse (third light pulse 100) that may be scattered from sample 45. Spectral filter 35 shapes the probe pulse to reduce scattered radiation from non-resonant contributions.

In the embodiment as illustrated in FIG. 1, first light pulse 90, second light pulse 95, and third light pulse 100 are focused on sample 45 by focusing lens 40. It is to be understood that detection system 5 is not limited to one focusing lens 40 but instead may have more than one focusing lens (or concave mirror) to focus the light pulses 90, 95, 100. For instance, in an embodiment (not illustrated), each of first light pulse 90, second light pulse 95, and third light pulse 100 have a focusing lens 40 to focus the respective light pulse on sample 45, mounted on sample holder 60.

In an alternative embodiment (not illustrated), first light pulse 90 and second light pulse 95 are provided by the same light source. For instance, signal and Idler outputs of an OPA may be used as a pump beam and Stokes beam, respectively. In another instance, a single light pulse from a femtosecond source may be used to play the role of both pump and Stokes pulses when the pulse duration is sufficiently short (i.e., 5 to 25 fs, such as to produce impulsive excitation for the transitions of interest). In another embodiment (not illustrated), first light pulse 90, second light pulse 95, and third light pulse 100 are all provided by the same light source. Another alternative embodiment (not illustrated) includes using signal and Idler outputs of an OPA as preparation pulses (i.e., as pump and Stokes) and an SHG of signal as a probe pulse.

As shown in FIG. 1, light pulses 90, 95, and 100 are collected by collection system 110 and focused on detector 80. Collection system 110 may include any suitable method for collecting and focusing light beams. In an embodiment as illustrated in FIG. 1, collection system 110 includes lens 65; alignment mirrors 50, 55; and lens 70. Lens 65 collates and collimates the scattered light. Alignment mirrors 50, 55 direct the light at the entrance of detector 80, with the light focused on the entrance by lens 70. In some embodiments, light reflected from alignment mirror 50 passes through spectral filters 75. In an embodiment, filters 75 include a set of bandpass and shortpass filters.

Detector 80 may be any type of detector suitable for use in detecting light. In an embodiment, detector 80 may detect a plurality of frequencies from the electromagnetic spectrum simultaneously. Without limitation, examples of suitable detectors 80 include a spectrometer with a CCD, a photodiode array, and the like. In an embodiment, detector 80 is a spectrometer. In some embodiments as illustrated in FIG. 1, a charge-coupled device 85 is attached to detector 80.

To further illustrate various illustrative embodiments of the present invention, the following examples are provided.

### Example

### Experimental Set-Up

The set-up used is illustrated by the detection system 5 shown in FIG. 1. A Ti:Sapphire regenerative amplifier (first light source 10) (1 kHz rep. rate, ˜1 mJ/pulse) was used to evenly pump two optical parametric amplifiers (OPAs) (OPerA-VIS/UV and OPerA-SFG/UV). The output of the first OPA (second light source 15) (λ₁=712-742 nm, tunable; FWHM˜12 nm) and a small fraction of the amplifier output (first light source 10) (λ₂=803 nm, FWHM˜32 nm) were used as pump and Stokes beams, respectively. The output of the second OPA (third light source 20) was used as the probe beam (λ₃=578 nm) and sent through a pulse shaper (spectral filter 35) with an adjustable slit (slit 105) that cut the bandwidth of the pulse.

The Stokes and probe pulses passed through delay stages (first delay stage 25 and second delay stage 30) and then all three beams were focused by a convex 2-inch lens (focusing lens 40) (with the focal length f=200 mm) onto a sample (sample 45). The scattered light was collected with a 2-inch achromatic lens (lens 70) (f=100 mm) and focused onto the entrance slit of a spectrometer (detector 80) (a CHROMEX SPECTROGRAPH 250 IS) with a liquid nitrogen cooled CCD (charge-coupled device 85) (a SPEC-10 from Princeton Instruments) attached.

By using a single laser source to provide the energy for the pump, Stokes, and probe beams, we were able to ensure that all three beams had precisely the same repetition rate, thereby naturally bypassing the problem of laser pulse synchronization between the multiple beams that is common to double-laser multiplex CARS setups.

### Detection of DPA

Calcium dipicolinate (CaDPA) is a marker molecule for bacterial endospores, such as Bacillus subtilis. CADPA accounted for 10% to 17% of the bacterial spore dry weight Although endospores are fairly complex in structure, their Raman spectra are dominated by several vibrational modes of CaDPA. We focus here on the detection of NaDPA, which exhibits a similar set of strong Raman lines as CaDPA but is easier to make.

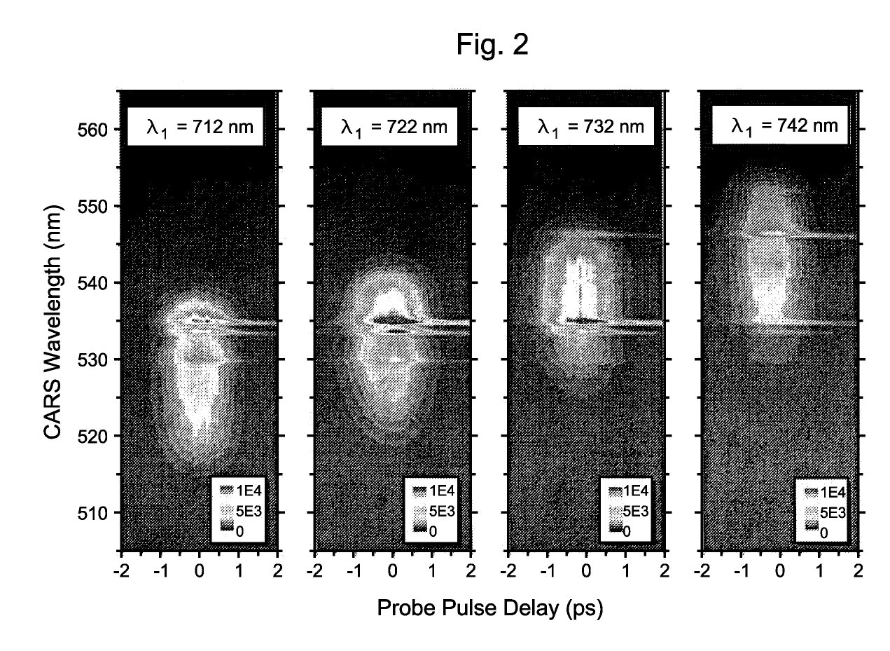

The two-dimensional CARS spectra of NaDPA powder are shown in FIG. 2. Each of these spectrograms were taken with the pump beam centered at four different wavelengths (λ₁=712, 722, 732, and 742 nm) to cover the spectral fingerprint region of the molecule (800 cm⁻¹ to 1700 cm⁻¹). The y-axis of the spectrograms corresponds to the wavelength of the scattered light measured as a function of the time delay (in picoseconds) between the coincident pump/Stokes pulses and the probe pulse. Streak-like horizontal lines were the signature of excited NaDPA Raman transitions. The broadband pedestal was the NR background. As expected, the tuning of the pump wavelength spectrally shifted the NR FWM but left the position of the resonant lines untouched.

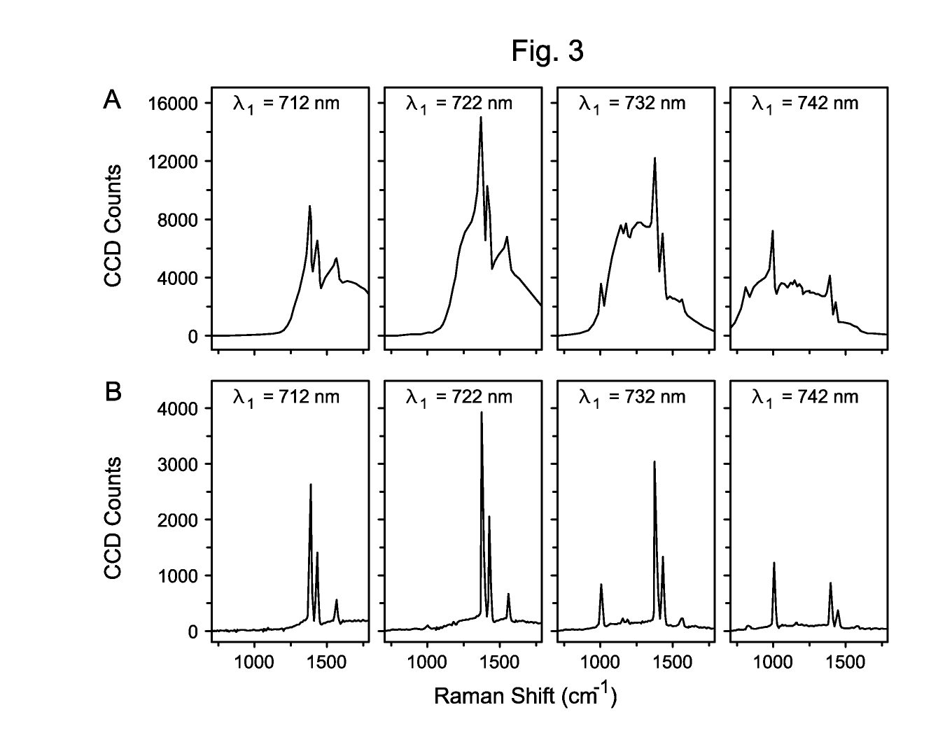

The cross-sections of the spectrograms at two different probe delays are given in FIG. 3. The integration time for each was only one second. As shown by the comparison between the top and bottom rows of FIG. 3, the NR and resonant contributions exhibited different dependence on the probe delay. The magnitude of the NR background was determined by the overlap of the three laser pulses and followed the probe pulse profile. As shown in the top row of FIG. 3, when the three pulses were overlapped (at zero probe delay), the resonant contribution was severely distorted by the interference with the NR FWM. In contrast, as shown in the bottom row of FIG. 3, the relatively long decay time of the Raman transitions excited by the pump and Stokes pulses allowed the vibrational modes to stand out when the probe was delayed. By delaying the probe by 1.5 ps to put the preparation pulses into the first node of the sinc-shaped probe pulse, the signal-to-background ratio was improved by at least an order of magnitude. In this latter case, the NR background suppression was limited by multiple scattering of the laser pulses in the sample, which scrambled the timing between the preparation and probe photons.

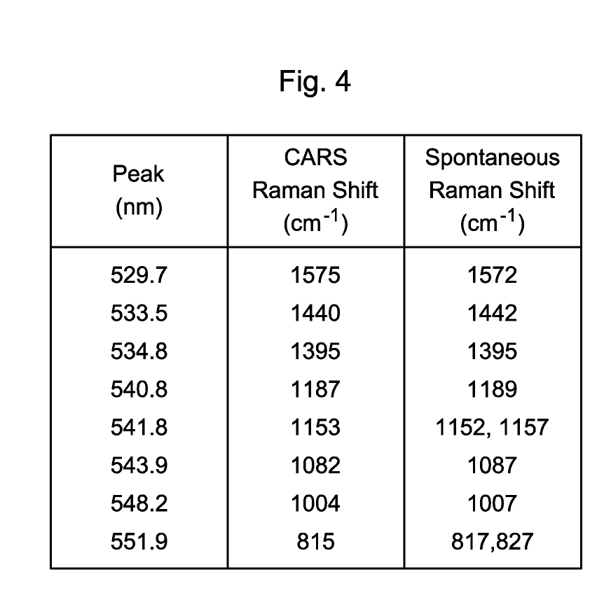

The absolute frequencies of the observed Raman transitions calculated from the retrieved peak positions and the probe wavelength are summarized in FIG. 4. Comparison with the data from spontaneous Raman measurements showed a remarkably good match.

### Detection of Bacillus Subtilis

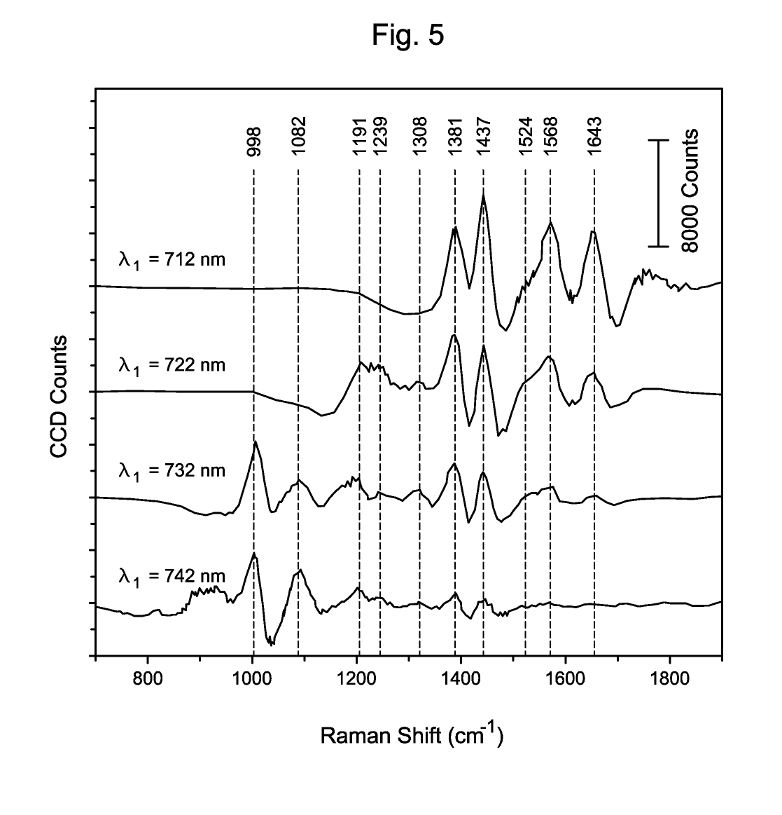

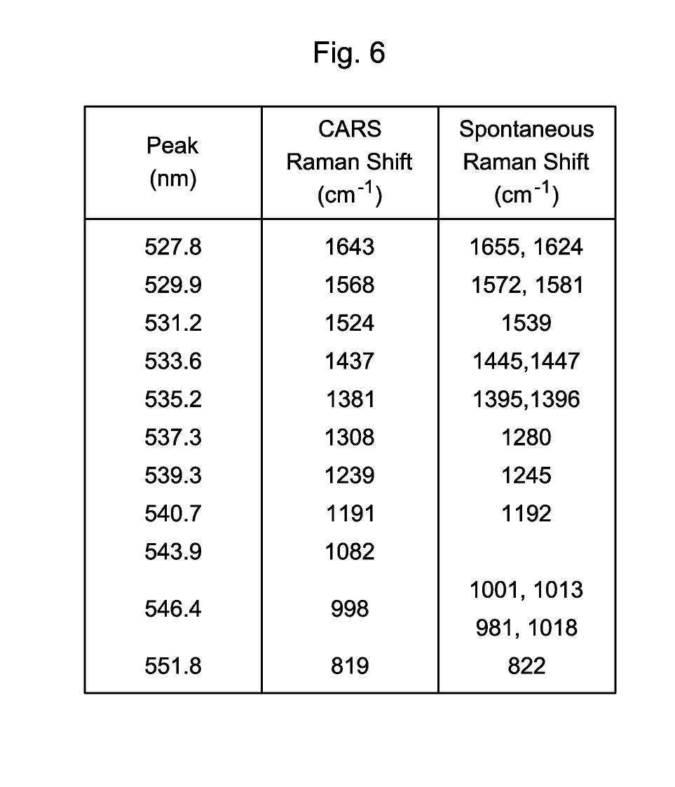

Extracted CARS contributions from the first measurements on Bacillus subtilis spores (a surrogate for anthrax), where the signal was maximized rather than the signal-to-background ratio, are summarized in FIG. 5. These spectrograms show the measured intensity of scattered radiation of the Raman shifted at four different pump beam wavelengths (λ₁=712, 722, 732, and 742 nm) at zero delay of the probe relative to the pump and Stokes beams. The Raman peaks were not normalized based on the strength of the excitation and thus had an imprint of the pump-Stokes spectral convolution function, which swept through the Raman band from 800 cm⁻¹ to 1700 cm⁻¹ while the pump wavelength was tuned. The Raman transitions in the band were assigned as shown in the data of FIG. 6, and the retrieved line positions were compared with the known lines from spontaneous Raman measurements. Within the estimated experimental uncertainty of 15 cm⁻¹, the values were in good agreement. Although the data shown in FIG. 6 was acquired at zero probe delay over a couple of minutes, the Raman lines stood out from the background after only a few seconds of integration. Under similar experimental conditions, the signal arising from spontaneous Raman scattering was much weaker (by several orders of magnitude) and consequently, typically requires a longer integration time before the Raman lines may be adequately observed.

Although the present invention and its advantages have been described in detail, it should be understood that various changes, substitutions and alterations may be made herein without departing from the spirit and scope of the invention as defined by the appended claims.

What is claimed is:

1. A detection system for measuring coherent anti-Stokes Raman signals of a sample, comprising:
a first light pulse and a second light pulse, wherein the first light pulse and the second light pulse are operable to initiate coherent vibration in the sample;
a third light pulse, wherein the third light pulse is a probe pulse that is operable to be scattered from the sample;
a spectral filter, wherein the spectral filter shapes the probe pulse; and
a detector to detect the scattered radiation.

2. The detection system of claim 1, wherein a first light source provides the first light pulse, a second light source provides the second light pulse, and a third light source provides the third light pulse.

3. The detection system of claim 1, wherein a light source provides both the first light pulse and the second light pulse.

4. The detection system of claim 1, wherein the first light pulse comprises a Stokes pulse and the second light pulse comprises a pump pulse.

5. The detection system of claim 1, wherein a light source provides a single light pulse operable as a pump/Stokes pair.

6. The detection system of claim 1, wherein the first light pulse is passed through a first delay stage.

7. The detection system of claim 1, wherein the third light pulse is passed through a second delay stage.

8. The detection system of claim 7, wherein the second delay stage is adjustable to reduce scattered radiation from non-resonant contributions of the sample.

9. The detection system of claim 1, wherein the spectral filter shapes the probe pulse to reduce scattered radiation from non-resonant contributions of the sample.

10. The detection system of claim 9, wherein the detector is a spectrometer.

11. The detection system of claim 1, wherein a lens focuses the first light pulse, the second light pulse, and the third light pulse on the sample.

12. A coherent anti-Stokes Raman spectroscopy method, comprising:
(A) illuminating a sample with a first light pulse and a second light pulse, wherein the first light pulse and the second light pulse initiate coherent vibration in the sample;
(B) shaping a third light pulse to produce a shaped third light pulse;
(C) illuminating the sample with the shaped third light pulse, wherein the shaped third light pulse is operable to produce scattered radiation from the sample; and
(D) detecting the scattered radiation.

13. The method of claim 12, wherein the shaped third light pulse reduces scattered radiation from non-resonant contributions of the sample.

14. The method of claim 12, further comprising delaying the shaped third light pulse, and wherein the first light pulse and the second light pulse coincide.

15. The method of claim 14, wherein the shaped third light pulse is delayed relative to initiation of the coherent vibration to reduce scattered radiation from non-resonant contributions of the sample.

16. The method of claim 12, wherein the third light pulse is shaped to have a spectral bandwidth greater than a Raman line width of the sample.

17. The method of claim 12, wherein a light source provides both the second light pulse and the third light pulse.

18. The method of claim 12, wherein the first light pulse and the second light pulse each have a duration less than about a picosecond.

19. The method of claim 12, further comprising focusing the first light pulse, the second light pulse, and the third light pulse on the sample.

20. The method of claim 12, wherein the detecting is accomplished with a spectrometer.
